(19) United States
(12) Patent Application Publication
(10) Pub. No.: US 2023/0313927 A1
(43) Pub. Date: Oct. 5, 2023

(54) VISUAL AND TACTILE INDICATOR

(71) Applicant: Oetiker Schweiz AG, Horgen (CH)

(72) Inventors: Markus WIDRIG, Horgen (CH); Maxime BÖSIGER, Horgen (CH); Tim WERNER, Horgen (CH); Melanie MÜLLER, Horgen (CH)

(73) Assignee: Oetiker Schweiz AG, Horgen (CH)

(21) Appl. No.: 17/862,578

(22) Filed: Jul. 12, 2022

(30) Foreign Application Priority Data
Apr. 4, 2022 (DE) 10 2022 108 053.6

(51) Int. Cl. F16L 33/025

(52) U.S. Cl. CPC F16L 33/025; F16L 2201/10

(57) ABSTRACT

The invention relates to a band clamp (10) with a clamping band (12) having an ear-like tightening device (14), an inner band end (18) having a tongue (20) extending in a longitudinal direction of the clamping band (12) and an outer band portion (22) including a recess (24), wherein the tongue (20) is configured to be inserted into the recess (24) when the tightening device (14) is being tightened.

It is proposed that the inner band end (18) includes an indicator structure (26) and the outer band portion (22) includes an opening window (28), wherein the indicator structure (26) is configured to engage with the opening window (28) and to be deformed when the tightening device (14) is being tightened.

The invention relates to a band clamp according to the preamble of claim 1.

The document US 2018-0187808 discloses a band clamp with an ear-like tightening device with a clamping band, an inner band end having a tongue extending in a longitudinal direction of the clamping band and an outer band portion including a recess, wherein the tongue is configured to be inserted into the recess when the tightening device is being tightened. The document U.S. Pat. No. 4,299,012 A1 discloses a further example of a band clamp with a tightening device and a tongue engaging in a recess.

In band clamps of the type as claimed, the recess is defined between two lateral band webs which transmit, within the circumferential section covered by the tongue, a fraction of the radial clamping force onto the hose, wherein this fraction gradually increases toward the end of the tongue so as to compensate a corresponding decrease of the clamping force transmitted by the tongue. As a result, a step in the clamping force, which would exist at the inner band end if no tongue engaging in a recess were provided, is avoided. Clamps of this kind are therefore referred to as “stepless”.

However, various errors may occur when mounting a band clamp as described above. It is possible that the inner band end and eventually some material of the hose being clamped gets caught between the legs of the tightening device, which is called “buckling”, or that the clamp is not completely closed for other reasons, e.g. non-permissible band elongation. Moreover, it is possible that the tongue is not correctly inserted into the recess and lies obliquely under the lateral band webs. Both errors decrease the sealing performance and reliability of the clamp.

The invention is based on the problem that it is difficult for the user to assert that the clamp is fully closed and that the tongue is sufficiently and correctly inserted into the recess or inside the guidance and the clamp is “stepless”. This holds in particular where clamps are mounted in places which are difficult to access, e.g. overhead or in narrow spaces.

The problem is solved by a device having the features of claim 1. Advantageous embodiments of the invention are defined in the dependent claims.

The invention relates to a band clamp with a clamping band having an ear-like tightening device, an inner band end having a tongue extending in a longitudinal direction of the clamping band and an outer band portion including a recess, wherein the tongue is configured to be inserted into the recess when the tightening device is being tightened.

It is proposed that the inner band end includes an indicator structure and the outer band portion includes an opening window, wherein the indicator structure is configured to engage with the opening window and to be deformed when the tightening device is being tightened. In particular, the deformation may be the result of a relative movement of the inner band end and the outer band portion, which slides in the longitudinal direction of the band when the tightening device is closed. The deformation of the indicator structure is both visible and palpable, such that the closing state can be visually and tactilely confirmed. In practice, the deformation may be such that the indicator structure is deformed but still visible or palpable or such that the indicator structure partially or completely vanishes in the opening window. The assembly worker can see and feel if the indicator structure is deformed or not, if it protrudes from the opening window or not, and conclude whether or not the band clamp is correctly closed. The indicator structure may help not only to confirm the complete closure of the clamp but also the correct pre-assembly configuration, i.e. the configuration where hooks and openings of a closing structure are closed but the tightening device is not tightened. Seeing and feeling the indicator element protruding from the opening window in this configuration indicates that the tongue is aligned with the recess. The indicator structure further helps guiding the tongue into the recess.

In a preferred embodiment of the invention, the indicator structure is configured to protrude through the opening window prior to the tightening of the tightening device and to slip under the outer band portion when the tightening device is being tightened. However, in alternative embodiments, the indicator structure could be configured to be erected by the tightening, i.e. lie flatly on an edge of the opening window in the non-tightened configuration and be bent upward by the edge of the opening window when the tightening device is being closed. It would further be possible to provide one clamp with both kinds of indicator structures.

It is further proposed that the indicator structure is arranged on the inner band end on the tongue or between the tightening device and the tongue. The closer the indicator structure is arranged to the tongue end, the more reliable the indication of the orientation of the tongue will be.

In a preferred embodiment of the invention, the indicator structure is formed as an indicator flap lanced out of the sheet metal material of the clamping band, with its free end oriented opposite to the free end of the tongue. In alternative embodiments of the invention, the indicator structure could be made of a different material or separate part.

In preferred embodiment of the invention, the opening window is stamped out the sheet metal material of the clamping band and an embossed stabilizing frame is provided around the opening window. The embossment hardens the material by cold hardening and the stabilizing frame can compensate the weakening of the band due to the opening window.

It is further proposed that the deformation of the indicator element takes place in the last quarter or third of the closing movement of the tensioning device, thereby avoiding that the indicator indicates a successful closure although the tightening device is closed to only 66%, 75% or less.

Further features and advantages will be apparent from the following description of the embodiments and figures. The entire description, claims and figures disclose features of the invention in specific embodiments and combinations. The person skilled in the art will also consider the features individually and combine them into further combinations or sub-combinations to adapt the invention, as defined in the claims, to his needs or to specific fields of application.

The figures illustrate the following:

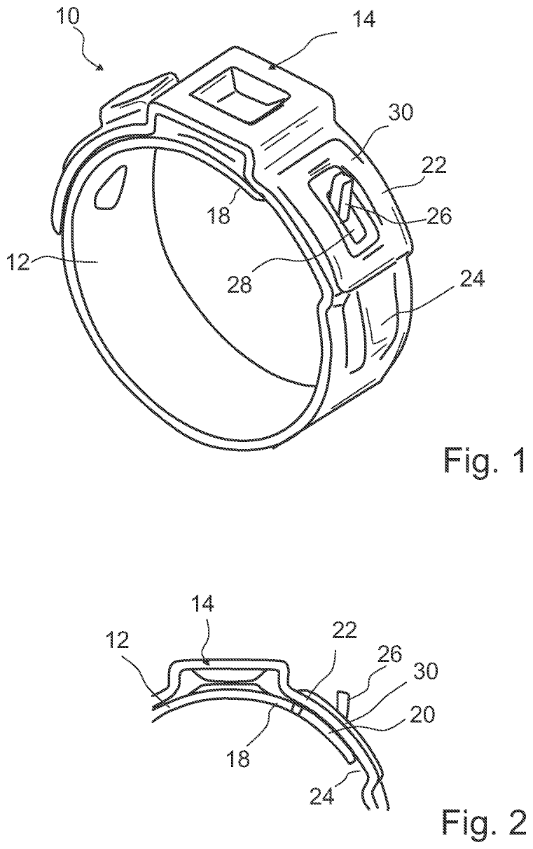

FIG. 1 is a band clamp according to a first embodiment of the invention in an untightened configuration;

FIG. 2 is a side view of the tightening device, the tongue and the indicator structure of the band clamp according to FIG. 1;

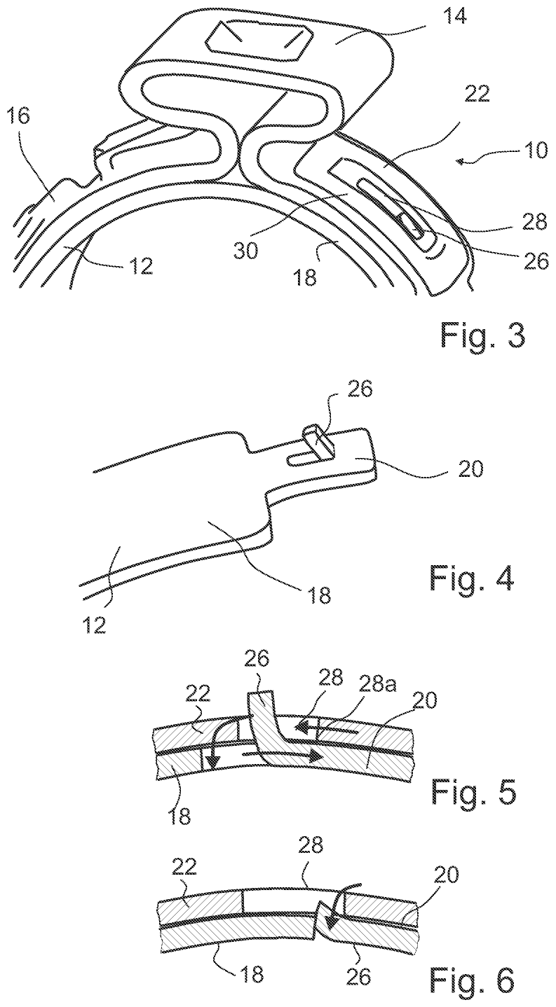

FIG. 3 is the band clamp according to FIG. 1 in a fully tightened configuration;

FIG. 4 is a detailed view of the tongue with the indicator structure of the band clamp of FIG. 1;

FIG. 5 is a schematic longitudinal section of the indicator structure of the clamp in an untightened configuration;

FIG. 6 is a schematic longitudinal section of the indicator structure of the clamp in a tightened configuration;

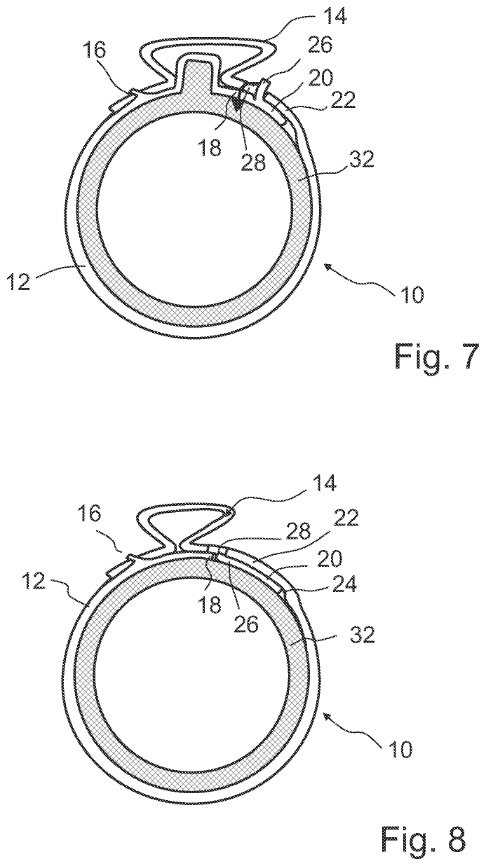

FIG. 7 is a schematic sectional view of a band clamp according to the invention with incomplete tightening due to buckling; and

FIG. 8 is a schematic sectional view of a band clamp according to the invention with a completely and correctly tightened tightening structure.

FIGS. 1, 2 and 3 show a band clamp 10 according to an embodiment of the invention. The band clamp 10 includes a clamping band 12 having an ear-like tightening device 14 with two legs connected by a cross-connection. The tightening device 14 may be tightened by means of a pincer pressing the legs together and eventually flattening the resulting loop-like ear. A tightened configuration in which the legs of the tightening device 14 are approached to each other or come in contact with each other as illustrated in FIG. 3 and will spring a little bit back after releasing the pincer. The band clamp 10 further includes a closing structure 16 with hooks on an inner band end 18 and corresponding openings on an outer band portion 22. At its very end, the inner band end 18 is provided with a tongue 20 extending in a longitudinal direction of the clamping band 12. The outer band portion 22 includes a recess 24, wherein the tongue 20 is configured to be inserted into the recess 24 when the tightening device 14 is being tightened.

According to the invention, the inner band end 18 further includes an indicator structure 26 formed as an indicator flap lanced out of the tongue 20 (FIG. 4) and the outer band portion 22 includes an opening window 28. The free end of the indicator structure 26 is oriented opposite to the free end of the tongue 20. In the pre-assembled configuration of FIGS. 1 and 2, i.e. when the closing structure 16 is closed and the tightening device 14 is not yet tightened, the indicator structure 26 engages with the opening window 28 and radially protrudes over the opening window 28 such that the indicator structure 28 is visible and tangible from the outside, i.e. protrudes beyond the upper surface of the upper band.

When the tightening device 14 is being tightened, the outer band portion 22 moves relative to the inner band end 18 as the tongue 20 is pushed into the recess 24 in the directions indicated by arrows in FIG. 5. In the last part of this movement, i.e. upon having completed roughly 66% of the movement, the indicator flap comes in contact with one longitudinal end 28a of the opening window 28 and is pressed down, so as to vanish in the opening window 28 and slip under the outer band portion 22 as illustrated in FIGS. 5 and 6. That is, the indicator structure 26 is deformed as a result of a relative movement of the inner band end 18 and the outer band portion 22, which slides in the longitudinal direction of the clamping band 12 when the tightening device 14 is closed. The deformation of the indicator structure 26 is both visible and palpable, such that the closing state can be visually and tactilely confirmed.

As illustrated in FIG. 5, the indicator structure 26 is configured to protrude through the opening window 28 prior to the tightening of the tightening device 14 and is visible and palpable in this configuration. The indicator structure 26 then slips under the outer band portion 22 when the tightening device 14 is being tightened, as illustrated in FIG. 6.

FIG. 3 is a perspective view of the band clamp 10 according to FIG. 1 in a fully tightened configuration, wherein the indicator structure 26 is no longer visible or palpable in the fully closed configuration of the band clamp 10 and FIG. 6 is a schematic longitudinal cross-sectional view of the same configuration.

As illustrated in FIGS. 1 and 3, the opening window 28 is stamped out the sheet metal material of the clamping band 12 and an embossed stabilizing frame 30 is provided around the opening window 28.

FIG. 7 is a band clamp 10 according to the invention in with incomplete tightening due to buckling of a hose 32 and the outer band portion 22 and FIG. 8 is a band clamp 10 according to the invention in which is completely and successfully closed such that the indicator structure is no longer visible or palpable.

In alternative embodiments of the invention, the indicator structure 26 could be erected rather than pressed down by the tightening of the tightening device 14. In this case, the indicator flap could protrude in the direction of the tongue 20 and be pushed radially outward by one end of the opening window 28. Other alternative embodiments include solutions where the indicator element is not stamped out of the clamping band 12 but rather formed as a separate piece.

### LIST OF REFERENCE NUMBERS

10 band clamp
12 band
14 tightening device
16 closing structure
18 inner band end
20 tongue
22 outer band portion
24 recess
26 indicator structure
28 opening window
30 stabilizing frame
32 hose

1. A band clamp (10) with a clamping band (12) having an ear-like tightening device (14), an inner band end (18) having a tongue (20) extending in a longitudinal direction of the clamping band (12) and an outer band portion (22) including a recess (24), wherein the tongue (20) is configured to be inserted into the recess (24) when the tightening device (14) is being tightened, wherein the inner band end (18) includes an indicator structure (26) and the outer band portion (22) includes an opening window (28), wherein the indicator structure (26) is con-figured to engage with the opening window (28) and to be deformed when the tightening device (14) is being tightened.

2. A band clamp (10) according to claim 1, wherein the indicator structure (26) is configured to protrude through the opening window (28) prior to the tightening of the tightening device (14) and to slip under the outer band portion (22) when the tightening device (14) is being tightened.

3. A band clamp (10) according to claim 1 wherein the indicator structure (26) is arranged on the inner band end (18) on the tongue (20) or between the tightening de-vice (14) and the tongue (20).

4. A band clamp (10) according to claim 1 wherein the indicator structure (26) is formed as an indicator flap stamped out of the sheet metal material of the clamping band (12), with its free end oriented opposite to the free end of the tongue (20).

5. A band clamp (10) according to claim 1 wherein the opening window (28) is stamped out the sheet metal ma-terial of the clamping band (12) and an embossed stabilizing frame (30) is provided around the opening window (28).

6. A band clamp (10) according to claim 1 wherein the deformation of the indicator structure (26) takes place in the last third of the closing movement of the tightening device (14).
